(19) United States
(12) Patent Application Publication
(10) Pub. No.: US 2024/0320684 A1
(43) Pub. Date: Sep. 26, 2024

(54) METHOD AND SYSTEM FOR AUTO SUMMARIZING CHAT CONVERSATION VIA MACHINE LEARNING AND APPLICATION THEREOF

(71) Applicant: Verizon Patent and Licensing Inc., Basking Ridge, NJ (US)

(72) Inventors: RajeshKhanna Singa Ramalingam, Dayton, NJ (US); Kumaradevan Chandrabose, Basking Ridge, NJ (US); Srinivasa Kaniganti, Frisco, TX (US); Sankar Shanmugam, Dayton, NJ (US)

(73) Assignee: Verizon Patent and Licensing Inc., Basking Ridge, NJ (US)

(21) Appl. No.: 18/189,358

(22) Filed: Mar. 24, 2023

(51) Int. Cl. G06Q 30/015; G06N 5/022

(52) U.S. Cl. CPC G06Q 30/015; G06N 5/022

(57) ABSTRACT

The present teaching relates to auto generated summaries of communications and enabled services. Summaries are automatically generated based on machine trained models for communications between customers and service agents. A summary modification history is created for each of the summaries including the machine generated summary and some updated versions of the summary. When a service request is received from a customer, a summary modification history of a prior communication associated with the customer is retrieved for responding to the request. Using the summary modification histories, feedback data is generated, which is then used for updating the models.

### BACKGROUND

Customer services are often provided via telephonic conversations between customers and service representatives. During such communications, customers may ask questions and service representatives may address and provide answers or resolutions to address issues raised by the customers. In recent years, it has becoming increasingly popular to provide customer service via online chat conversations between customers and chat agents made available by a service provider on its website.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary customer service framework that operates via automatically generated chat summaries, in accordance with an embodiment of the present teaching;

FIG. 1B is a flowchart of an exemplary process of the frontend of a customer service framework that operates via automatically generated chat summaries, in accordance with an embodiment of the present teaching;

FIG. 1C is a flowchart of an exemplary process of the backend of a customer service framework that facilitates automatic adaptation of models for generating chat summaries, in accordance with an embodiment of the present teaching;

FIG. 2A depicts an exemplary high level system diagram of a chat summary based (CSB) service engine of a customer service framework, in accordance with an embodiment of the present teaching;

FIG. 2B is a flowchart of an exemplary process of the CSB service engine of a customer service framework, in accordance with an embodiment of the present teaching;

FIG. 3A depicts an exemplary high level system diagram of an automated chat summary generator, in accordance with an embodiment of the present teaching;

FIG. 3B is a flowchart of an exemplary process of automatically generating a chat summary based on trained models, in accordance with an embodiment of the present teaching;

FIG. 3C is a flowchart of an exemplary process of adapting models used for generating chat summaries based on assessment feedback, in accordance with an embodiment of the present teaching;

FIG. 4 illustrates an exemplary structure of a chat summary modification history, in accordance with an embodiment of the present teaching;

FIG. 5A depicts an exemplary high level system diagram of a chat summary quality assessment unit, in accordance with an embodiment of the present teaching;

FIG. 5B is a flowchart of an exemplary process of a chat summary quality assessment unit, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching is directed to a service framework that simultaneous enables customer services via multiple channels. In some embodiments, the multiple channels include an online chat conversation platform to facilitate customer-chat agent communications and a call-in customer service that allows a customer to talk to a representative to ask questions and raise issues. The customer services via multiple channels may be facilitated by automatically generating, based on machine learned models, summaries of online chat communications between customers and chat agents. In operation, such automatically generated summaries may aim to capture the content of a communication in terms of some information categories such as the issue/situation, actions to be taken, and the resolution to the issue. To ensure such automatically generated chat summaries capture the information in such categories, an automatically generated chat summary may be modified by, e.g., the agent engaged in the communication to ensure to capture different aspects of the conversation between a customer and a chat agent. For instance, during an online chat, a customer may ask questions, raise issues observed in the service, and request for certain solutions; while a chat agent may answer questions, discuss about the issues raised by the customer, and offer resolutions to address the issues raised. Such key points in the communication are included in the chat summary. In some situations, a summary may be modified multiple times and different versions of the summary may form a modification history.

A chat summary, including its modified version(s) of the initial automatically generated chat summary, may be used as the basis or record to facilitate subsequent communications with the same customer in future services. In some embodiments, a chat summary related to a customer may be archived as a history of customer service associated with the customer, which may be retrieved when the same customer calls a service representative to follow up on some issues subsequently. Given that, capturing all aspects of an online chat in a chat summary is important in order to successfully facilitate future communications with customers. Modifying a machine generated chat summary provides a means to ensure that. The modifications applied to the automatically generated chat summaries may be utilized for updating the models for automatic chat summary generation so that the quality of chat summaries generated using such models may be improved. In some embodiments, some data associated the process of creating chat summaries by different agents may also be recorded and utilized for evaluating the performance of the chat agents within the service framework according to the present teaching.

Histories of modifying machine generated chat summaries may be utilized to adapt the models for automatically generating chat summaries. Such histories may be dynamically assessed as to discrepancies between a machine generated chat summaries and modified chat summaries to generate assessment feedback, which may then be used as updated training data for machine learning to update the models in accordance with the assessment so that the quality of subsequently generated chat summaries using such adapted models may possess improved qualities.

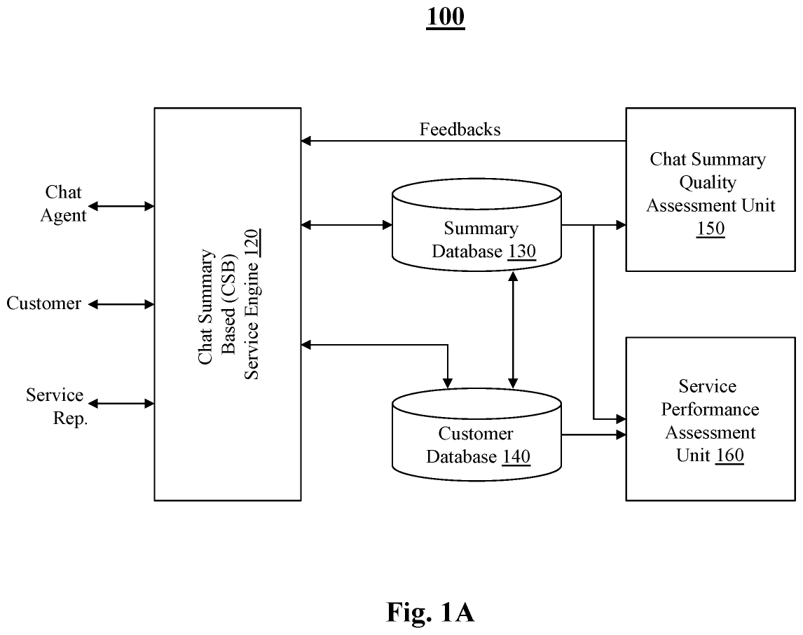

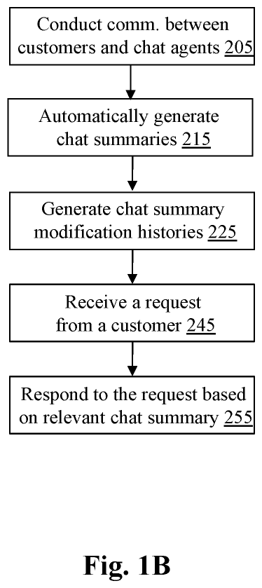

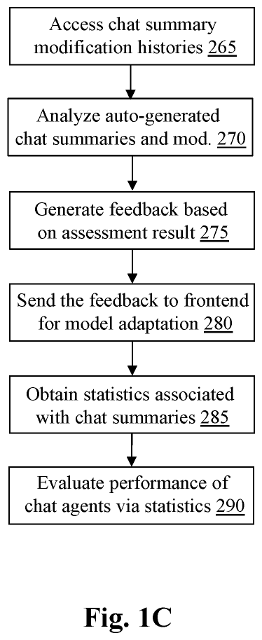

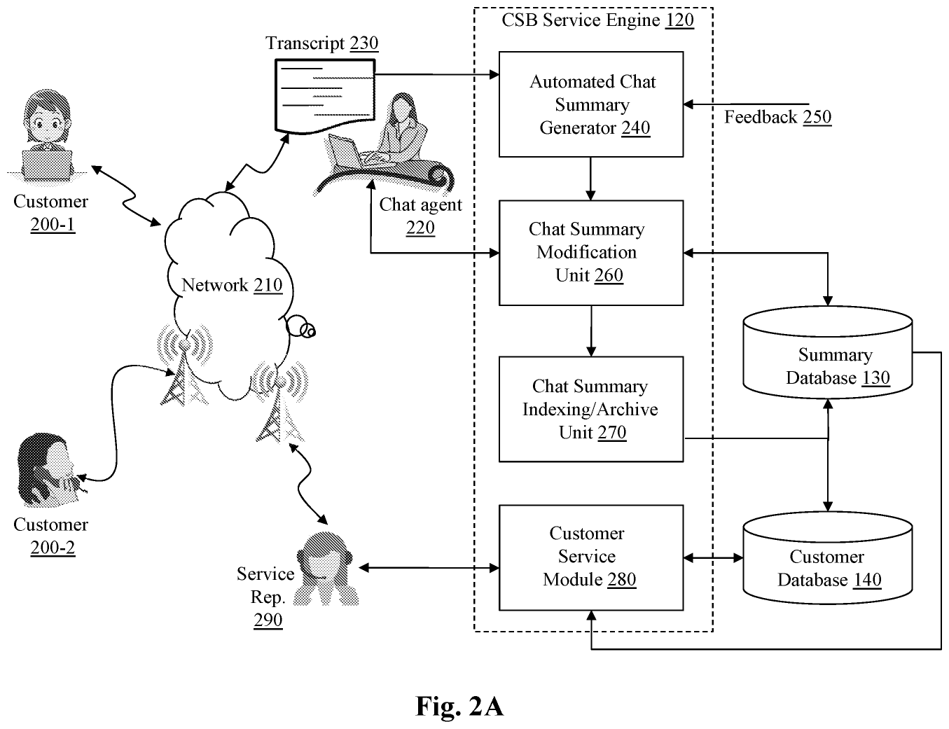

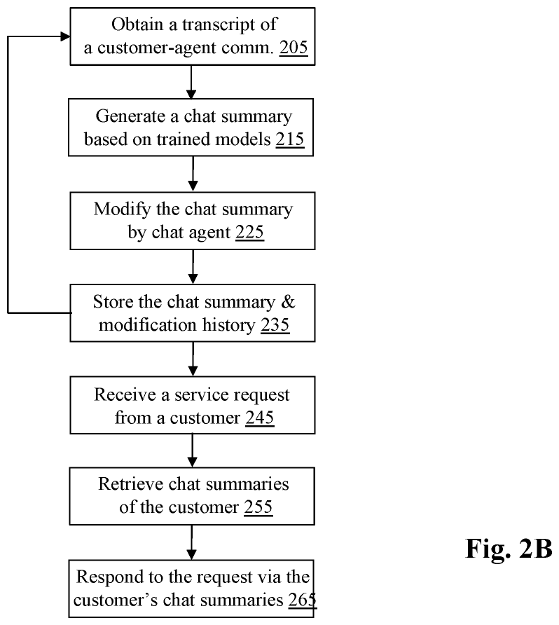

FIG. 1A depicts an exemplary customer service framework 100 that operates via automatically machine generated chat summaries, in accordance with an embodiment of the present teaching. As illustrated, this exemplary framework 100 includes a frontend for interfacing with customers/users to provided services via either chat agents on a website or a service representative via calls. The framework 100 also includes a backend for functions provided to facilitate/improve the services provided by the frontend. In some embodiments, the frontend of the customer service framework 100 corresponds to a chat summary based (CSB) service engine 120 that are used for customers and service personnel (including chat agents and service representatives) to communicate with each other for services. Details regarding CSB service engine 120 are provided with reference to FIGS. 2A-4.

The backend of the customer service framework 100 includes archived information created via the CSB service engine 120, which includes a summary database 130 and a customer database 140, as well as a chat summary quality assessment unit 150 and a service performance assessment unit 160. In some embodiments, the summary database 130 records the modification histories of automatically generated chat summaries and such modification histories may be utilized by the chat summary quality assessment unit 150 to assess the quality of machine generated chat summaries. Such assessment may be used to generate feedbacks that may then be utilized by the frontend or CSB service engine 120 to adjust the models for automatically generate the chat summaries to aim to create chat summaries of improved qualities.

A modified summary for an online chat involving a customer may capture different aspects of the chat, e.g., issues discussed and resolutions thereof. Such a chat summary may be stored in the summary database 130 and indexed based on, e.g., an identification of the customer and each chat summary associated with the same customer may be further indexed based on, a date and time of the chat. As discussed herein, the customer database 140 stores information associated with customers and such customer information may be stored, indexed, and retrieved based on customer identifiers. With both the chat summaries in database 130 and user information in customer database 140 indexed based on customer identifiers, the chat summaries associated with each customer may be retrieved via an identifier of each customer whenever it is needed. For instance, a customer may be engaged in a chat with a chat agent at some point, via the CSB service engine 120, about an issue associated with the service and may discuss a resolution. The summary of this chat may be stored and indexed based on the identifier of the customer and the date and time of the particular chat. At a later point in time, the same customer may make a call to a service representative, inquiring about the status of the discussed resolution. To provide a response to the inquiry from the customer, the service representative may, via the CSB service engine 120, retrieve the chat summary for the particular chat from the summary database 130 in order to continue the communication with the customer. In this manner, the chat summary from the earlier conversation is used to facilitate a service engagement that occurred later in time.

The service performance assessment unit 160 may be provided for backend management need for, e.g., evaluating the performance of chat agents based on, e.g., meta data associated with online chat communications with customers. In some embodiments, such meta information may include, but is not limited to, statistics associated with the online chats. For instance, based on chat communications, information may be automatically gathered on, e.g., a total number of number of chats occurred during each unit time (e.g., a day, a week, a month, etc.) with respect to each chat agent, a number of chat summary automatically generated, a number of chat summaries modified by the chat agent, and a number of chat summaries submitted to the database 130. Such statistics may be utilized by management to evaluate the performance of each chat agent. For example, if the number of chats that have occurred is higher than the number of chat summaries the chat agent submitted to the database 130, then there may be performance issue. If the number of modifications on chat summaries over a period of time is much lower than an average number of modifications the same chat agent applies to auto-generated chat summaries, some irregularities may be observed. The information to be collected based on online chats may be determined based on application needs.

FIG. 1B is a flowchart of an exemplary process of the frontend operation of the customer service framework 100 that enables customer services via automatically generated chat summaries, in accordance with an embodiment of the present teaching. Via website platform, customers and chat agents conduct conversations at 205 via the CSB service engine 120. The transcripts generated from the online chats are used to automatically generate, at 215, chat summaries based on machine learning models. Each of the generated chat summaries may be modified by the chat agents to generate, at 225, chat summary modification histories. As discussed herein, the machine generated chat summaries, their modification histories, and optionally different types of meta information associated with the online chats may then be stored in the summary database 130 with indices established for retrieval based on, e.g., identifiers of the customers and the date/time of the chats. In some embodiments, the chat summary modification histories may also be indexed against the identifiers of the chat agents in order to obtain certain statistics that may be used for evaluation. The stored online chat summaries and their modification histories may be utilized in subsequent services to customers when customers seek services via a different service channel such as a call to a service representative. When a request from a customer is received at 245, the service representative may access previously stored chat summary/summaries associated with the customer and respond, at 255, to the customer's request based on the retrieved online chat summary/summaries.

FIG. 1C is a flowchart of an exemplary process of the backend portion of the customer service framework 100, in accordance with an embodiment of the present teaching. As discussed herein, in the backend, feedback as to the quality of machine generated online chat summaries may be generated based on chat summary modification histories stored in 130. In addition, statistics may be obtained based on data associated with the stored chat summaries and their modification histories so that the performance of chat agents may be assessed based on such statistics. In operation, the chat summary quality assessment unit 150 may access, at 265, chat summary modification histories of different online chats and analyze, at 270, the initial machine generated chat summaries with respect to their respective modification histories. Based on the analysis results, feedback is generated at 275 based on, e.g., the discrepancies from machine generated chat summaries to corresponding final version of the chat summaries. In some embodiments, the discrepancies may be based on the initial machine generated chat summaries and the final chat summaries. In some embodiments, the discrepancies may be based on the incremental differences of adjacent versions starting from the initial machine generated chat summaries and ending at the final version. In some embodiments, the discrepancies between the initial and final versions as well as incremental discrepancies may both be used to generate the feedback.

In some embodiments, the feedback is generated in the form of training data to be used by the front end (i.e., the CSB service engine 120) to adapt the models for automatically generating chat summaries. In some embodiments, the training data may include, with respect to each chat summary included in the feedback, the original chat transcript, and the final version of the chat summary as ground truth with, e.g., some scores or weights to be used for learning and determined based on, e.g., the discrepancies detected from the modification histories. Upon receiving such training data created from the chat summaries and modification histories, the CSB service engine 120 may then adjust the models according to the feedback from the operation by, e.g., machine learning based on the newly generated training data.

As discussed herein, another optional aspect of operation in the backend of the service framework 100 is to evaluate chat agents' performance based on data associated with the chat summaries and modification histories. This may be carried out via the service performance assessment unit 160, which, when activated, may determine, at 285, statistics based on data recorded in the summary database 130. The statistics computed may vary depending on the category of evaluation being performed. For instance, in some embodiments, the evaluation may be directed to the level of skill exhibited by chat agents in providing services, measured by, e.g., how quickly a chat agent is able to extract the important information from chats or whether chat agents have promptly submitted the finalized chat summaries to database 130, without excessive delay after the chat has ended, in order to facilitate subsequent service requests, etc. Depending on the need of each evaluation, certain statistics may be computed according to some configuration. Upon obtaining the needed statistics, the service performance assessment unit 160 may then carry out the evaluation at 290 to assess the performance of each chat agent according to some pre-determined criteria.

FIG. 2A depicts an exemplary high level system diagram of the CSB service engine 120 and its connections with relevant parts of the framework 100, in accordance with an embodiment of the present teaching. As discussed herein, this frontend portion of the customer service framework 100 provides a platform for customers and the service team to interface and deliver services. To facilitate services, the CSB service engine 120 may also function to collect relevant service related information and archive such information in the summary database 130 and/or customer database 140.

In the illustrated embodiment in FIG. 2A, a customer may interact with a service personnel via different channels via a network 210. In some situations, a customer 200-1 may access a website of the service provider and chat with a chat agent 220 through a network connection via network 210. In some situations, a customer 200-2 may reach out to the service provider by making a telephone call, via the network connection 210, to a service representative 290. In the illustrated embodiment, the network 210 may be a single network or a combination of different networks. The communications between customers and the service team are conducted through the network 210. For instance, customer 200-1 may type in text, in a chat interface, that is transmitted to the chat agent 220 via the network 210 during an online chat. The correspondence text from the chat agent 220 may also be delivered to the chat interface of the UE of the customer 200-1 via the network 210. When customer 200-2 calls service representative 290, the voice of customer 200-2 may be transmitted via a VoIP application to an access point in the network 210 and is delivered to service representative 290 and vice versa.

The network 210 may be a local area network (LAN), a wide area network (WAN), a public network, a private network, a proprietary network, a Public Telephone Switched Network (PSTN), the Internet, a wireless network, a virtual network, or any combination thereof. Such a network or any portions thereof may be a 4G network, a 5G network, or a combination thereof. The network 10 may also include various network access points, e.g., wired, or wireless access points such as base stations or Internet exchange points, through which a particular party in customer service framework 100 may connect to the network in order to provide and/or transmit information to a specific destination. The information communicated among parties via the network 210 may be delivered as bitstreams which may be encoded in accordance with certain industrial standards, such as MPEG4 or H.26×, and the network may be configured to support the transport of such encoded data streams.

To provide services, the service team (including chat agents and service representatives) interfaces with both customers and the CSB service engine 120 to carry out service related functions. The present teaching discloses the aspects of such services that are facilitated by chat summaries created automatically based on chat transcripts in accordance with models learned via training and adapted dynamically over the course of providing services. The CSB service engine 120 comprises an automated chat summary generator 240, a chat summary modification unit 260, a chat summary indexing/archive unit 270, and a customer service module 280. In this illustrated embodiment, the automated chat summary generator 240 is provided to automatically generate a chat summary based on a transcript from an online chat between a customer and a chat agent. The chat summary modification unit 260 is provided as an optional unit which is to be used to interface with a chat agent to modify a chat summary, which may correspond to an automatically generated chat summary or a previously modified chat summary (e.g., retrieved from the summary database 130.

An automatically generated chat summary may be stored in the summary database 130 in an indexed manner for future retrieval. As discuss herein, the index may be based on different attributes, e.g., the identifier of the customer involved, the identifier of the chat agent, or date and time of the chat. The chat summary indexing/archive unit 270 may be provided for establishing appropriate indices for different chat summaries or their modified versions and then store them in the summary database 130. With properly established indices, chat summaries and/or modifications thereof may be located in database 130 based on any of the existing indices and retrieved to serve different purpose in different situations. For example, a chat agent may retrieve all chat summaries generated based on online chats that the agent is engaged in in order to, e.g., review and make modifications. A chat summary (or a modified version thereof) may also be retrieved by a service representative 290, via customer service module 280, based on an identifier of a customer involved in an online chat on a particular date and time. The customer service module 280 may be provided for interfacing with a service representative 290 to, e.g., answer questions from a call-in customer (e.g., 220-2) or address any concerns raised by the call-in customer. To do so, the service representative 290 may access information related to the customer stored in customer database 140, or information relating to a service history of the customer stored in 130 based on customer's identifier and/or relevant dates/times.

FIG. 2B is a flowchart of an exemplary process of the CSB service engine 120 of the customer service framework 100, in accordance with an embodiment of the present teaching. In operation, when a transcript associated with an online chat between a customer and a chat agent is obtained at 205, the automated chat summary generator 240 generates at 215, a chat summary based on models previously trained. The machine generated chat summary may be modified at 225 by the chat agent and via chat summary modification unit 260 to ensure that the final version of the chat summary covers what was discussed and/or agreed to during the chat. The chat summary and its modification history may be indexed according to some pre-determined configuration and stored, at 235, by the chat summary indexing/archive unit 270. Subsequently, when a service request (e.g., a call) is received, at 245, from a customer who was involved in a previous chat, the customer service module 280 retrieves, at 255, chat summary/summaries relevant to the current service request. Such retrieved customer's chat summary/summaries may then be used by the service representative to respond, at 265, the service request from the customer.

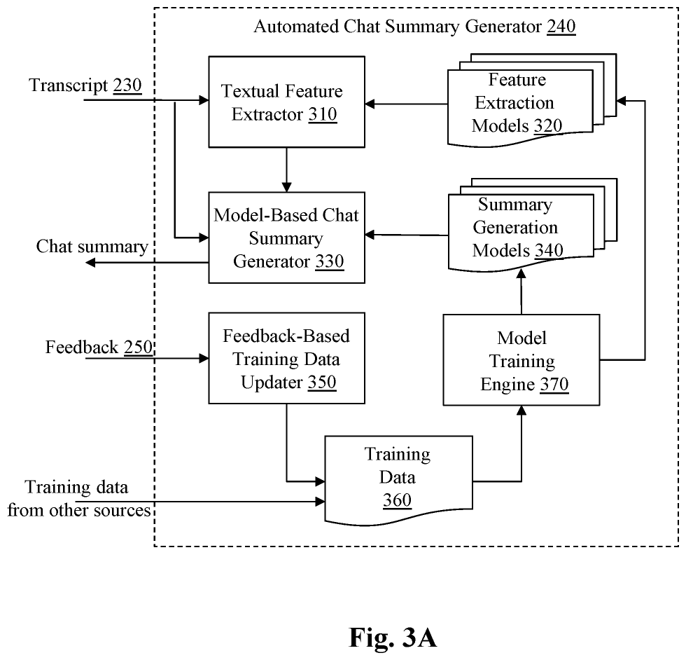

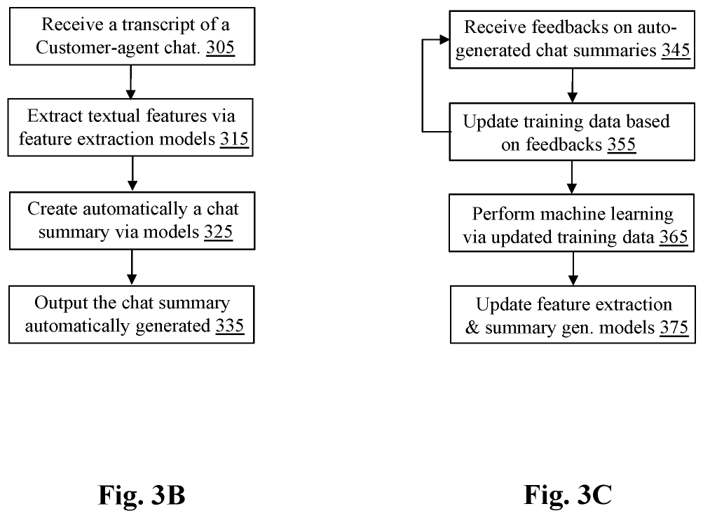

As disclosed herein with respect to the present teaching, the automated chat summary generator 240 is for creating a chat summary based on a transcript recording the online conversion with a customer in accordance with models previously machine learned via training. FIG. 3A depicts an exemplary high level system diagram of the automated chat summary generator 240, in accordance with an embodiment of the present teaching. In this illustrated embodiment, the automated chat summary generator 240 includes two portions, one for creating a chat summary using trained models and the other for learning the models via training. The first portion comprises a textual feature extractor 310 and a model-based chat summary generator 330. The former is provided for extracting textual features for generating a chat history based on feature extraction models 320 and the latter is provided for creating a chat summary from an input textual transcript based on features extracted from the transcript and summary generation models 340.

The second portion of the automated chat summary generator 240 is provided for deriving models used for generating chat summaries via, e.g., machine learning based on training data. This portion comprises a model training engine 370 and a feedback-based training data updater 350. The model training engine 370 is provided for training, via learning from training data 360, both the feature extraction models 320 and the summary generation models 340. The feedback-based training data updater 350 is provided to enable adaptation of models 320 and 340 based on feedbacks 250 received from the chat summary quality assessment unit 150 (see FIG. 1A) in the backend of the customer service framework 100. The training data 360 used for learning models (320 and 340) may be obtained from different sources. For example, to dynamically adjust models 320 and 340 for achieving improved quality of auto-generated chat summaries, the feedbacks 250 obtained by the chat summary quality assessment unit 150 based on the chat summary histories may be continually added to the training data 360 so that re-training based on such feedback data may yield enhanced models. The training data 360 may also include data from other sources.

FIG. 3B is a flowchart of an exemplary process of the first portion of the automated chat summary generator 240 for automatically generating a chat summary based on trained models, in accordance with an embodiment of the present teaching. In operation, when the textual feature extractor 310 receives, at 305, a transcript associated with an online chat, it extracts textual features at 315 based on feature extraction models 320. Based on the textual features as well as the transcript, the model-based chat summary generator 330 creates, at 325, a chat summary using the summary generation models 340. The machine generated chat summary is then output, at 335, so that it may be stored in database 130. With respect to model adaptation, when the feedback-based training data updater 350 receives, at 345, the feedback data from the backend, it processes the received feedback and updates, at 355, the training data stored in 360. This process of incorporating feedback data into the training data may be continuous as shown by the link between 355 to 345.

FIG. 3C is a flowchart of an exemplary process of the second portion of the automated chat summary generator 240 for training models used for generating chat, in accordance with an embodiment of the present teaching. With the training data 360 available, whether it is before or after it incorporates the feedbacks, the model training engine 370 carries out training at 365 via, e.g., machine learning. In some embodiments, the training may be performed as an iterative process and at each iteration of the learning process, parameters of models (320 and 340) may be adjusted to minimize some pre-configured loss function so that discrepancies between machine generated chat summaries from the parameterized models and the ground truth chat summaries provided in the training data may be minimized. The iterative process converges when the pre-configured loss function is satisfied. Whenever more training data is obtained, such as feedback from the backend of the customer service framework 100, the learning process may be carried out based on the updated training data so that existing model parameters can be further adjusted so that the models may be adapted to learn the knowledge embedded in the updated training data. The re-training may be made ongoing so that parameters of both the feature extraction models 320 and the chat summary generation models 340 may be updated, at 375, to yield adapted models.

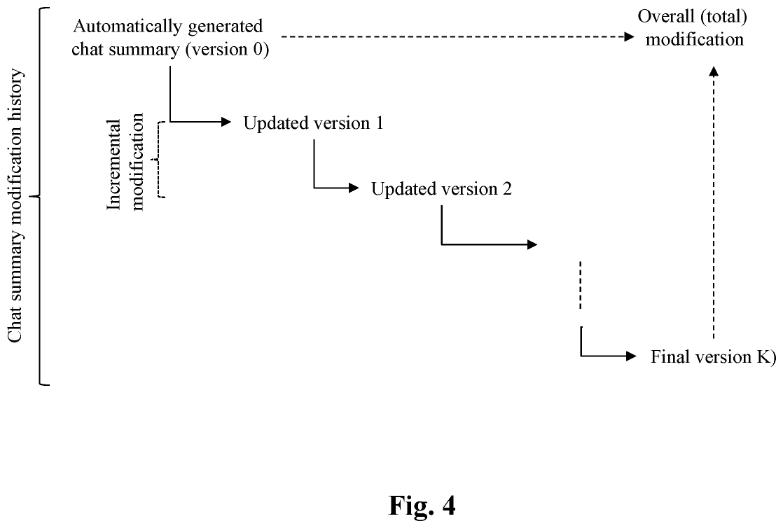

As discussed herein, the adaptation may be achieved based on feedback indicative of quality of chat summaries generated automatically based on models, while the feedback is derived from chat summary modification histories. FIG. 4 illustrates an exemplary structure of a chat summary modification history, in accordance with an embodiment of the present teaching. For each chat, there is an initially machine generated chat summary (version 0). This machine generated chat summary may be modified by chat agent subsequently to generate different updated versions, e.g., updated version 1, updated version 2, . . . , and the final version of the chat summary. The discrepancy between the initial and the final versions of the chat summaries may be indicative of the quality of the machine generated chat summary, i.e., the bigger the discrepancy, the worse quality of the machine generated chat summary. The discrepancies among different versions of the chat summary due to incremental modifications may also be utilized in evaluating the quality of the machine generated chat summary. The evaluation may be carried out on all chat summary modification histories and can be integrated to estimate an overall assessment on the quality of the machine generated chat summaries.

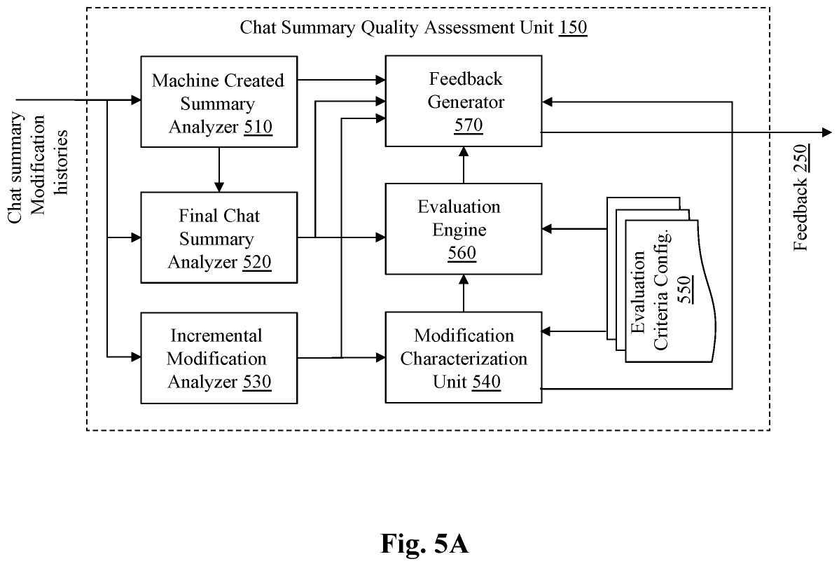

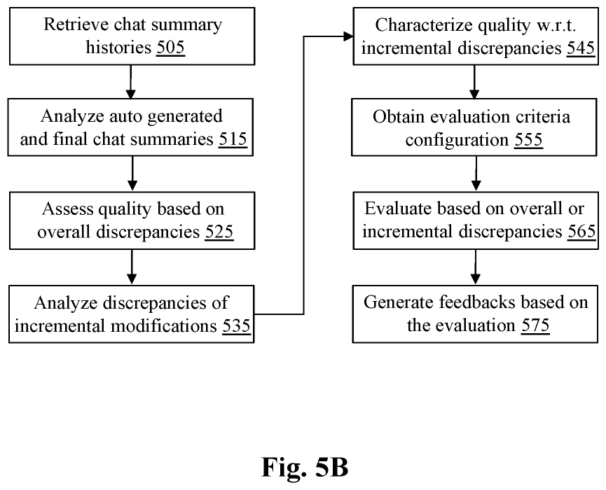

FIG. 5A depicts an exemplary high level system diagram of the chat summary quality assessment unit 150, in accordance with an embodiment of the present teaching. In this illustrated implementation, the chat summary quality assessment unit 150 takes chat summary modification histories as input, assess the quality of machine generated chat summaries, and outputs feedback 250. To achieve that, it comprises a machine created summary analyzer 510, a final chat summary analyzer 520, an incremental modification analyzer 530, a modification characterization unit 540, an evaluation engine 560, and a feedback generator 570. In this illustrated embodiment, the evaluation engine 560 is provided to assess the quality of machine generated chat summaries or the suitability of the models used for generating chat summaries.

Certain metrics may be defined and used to quantitatively characterize the quality of machine generated chat summaries. In some embodiments, if the machine generated summary is similar to the final version of the chat summary, it may indicate a good quality. If the discrepancy between the machine generated and the final version of chat summaries is significantly large, characterized by a metric such as a similarity measure, then it may indicate the chat summary is of low quality. The metric may be defined to characterize such a discrepancy assessment numerically. For example, a similarity measure may be used, including, e.g., the Jaccard similarity measure, the Jarowinkler measure, the Dice-coefficient, the Levenshitein Distance measure, etc. For instance, if Jaccard similarity is 96.15% (or 0.96), then it quantitatively indicates that a final chat summary is almost identical to the corresponding machine generated chat summary, i.e., the quality of the machine generated chat summary is quite good.

FIG. 5B is a flowchart of an exemplary process of the chat summary quality assessment unit 150, in accordance with an embodiment of the present teaching. Upon retrieving chat summary modification histories at 505, the machine created summary analyzer 510 may analyze the machine generated chat summaries (version 0) and the final chat summary analyzer 520 may analyze the final versions of the chat summaries at 515. In some embodiments, metrics may be determined based on the overall discrepancies between the machine generated and final chat summaries and the metrics may be used to assess at 525, the quality of machine generated chat summaries. In some embodiments, the assessment may also rely on discrepancies observed from incremental modifications among different versions. In this case, the incremental modification analyzer 530 captures, at 535, discrepancies of incremental modifications of different versions and the modification characterization unit 540 may characterize, at 545, the quality of machine generated chat summaries based on the incremental discrepancies. In some embodiments, some metrics may be computed based on the incremental discrepancies as indication of quality. It is noted that metrics related to the overall discrepancy and the incremental discrepancies may be defined based on application need.

Based on the metrics as well as the detected discrepancies, the evaluation engine 560 may carry out evaluation according to a predetermined manner. For instance, in some embodiments, the evaluation may be based on the metrics related to the overall discrepancy. In some embodiments, the evaluation may be conducted based on metrics characterizing both the overall and incremental discrepancies. The evaluation engine 560 may obtain, at 555 from the evaluation criteria configuration 550, the pre-configured evaluation criteria and then derive, at 565, an assessment of the quality of the machine generated chat summaries. The evaluation, the discrepancies, as well as the chat summaries of different versions are then sent to the feedback generator 570, which then generates, at 575, feedback data 250. As discussed herein, the feedback data 250 is to be used as training data for adapting the models for generating chat summaries.

As disclosed above, the feedback data generated based on chat summaries corrected by chat agents during the operation of servicing customers is reflective of what is the chat summaries that chat agents view as satisfactory when it comes to capturing important aspects of an online chat. Not only may the corrected chat summaries be used in later services, but they may also be used as ground truth chat summaries to adapt the chat summary generation models. In this manner, the customer service platform 100 as disclosed herein is a self-adapting system with the ability of bootstrapping itself based on data created during customer services.

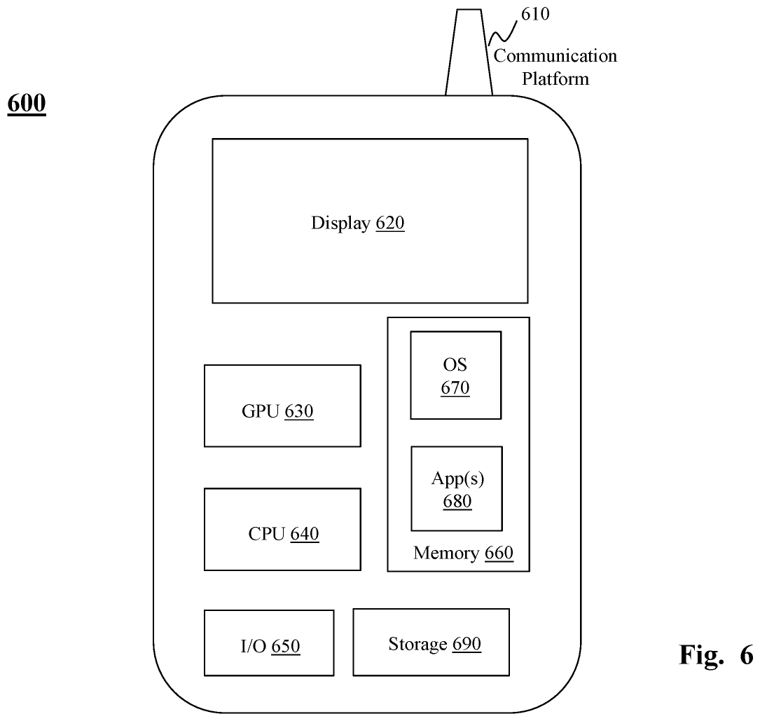

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or a mobile computational unit in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.) and one or more applications 680 may be loaded into memory 660 from storage 690 in order to be executed by the CPU 640. The applications 680 may include a user interface or any other suitable mobile apps for information exchange, analytics, and management according to the present teaching on, at least partially, the mobile device 600. User interactions, if any, may be achieved via the I/O devices 650 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

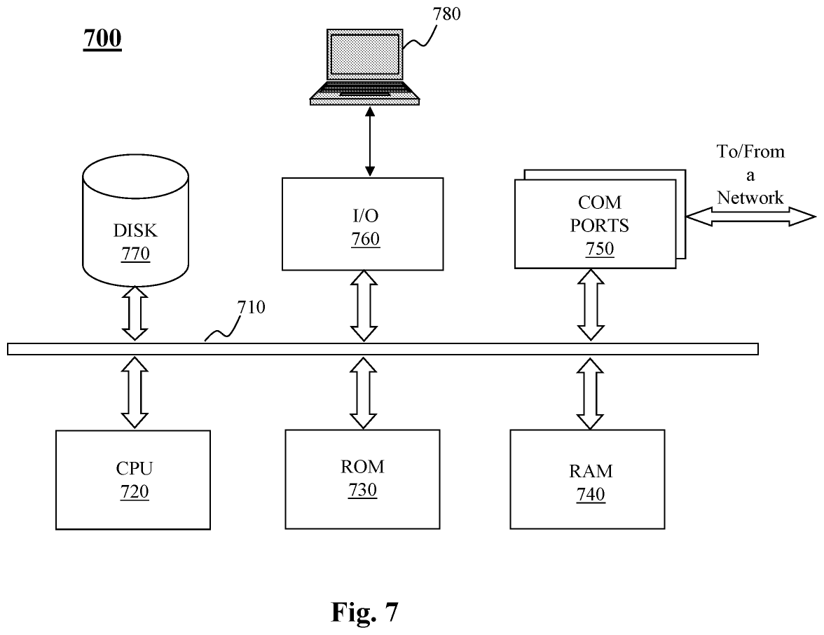

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information processing and analytical method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
automatically generating chat summaries for communications between customers and service agents based on one or more pretrained models;
creating a chat summary modification history for each of the chat summaries, wherein the chat summary modification history incudes a chat summary automatically generated using the models and one or more updated versions of the chat summary;
receiving a request from an inquiring customer;
responding to the request based on a chat summary modification history created with respect to a chat summary on a previous communication involving the inquiring customer;
generating feedback data based on the chat summary modification histories; and
updating the models based on the feedback data.

2. The method of claim 1, wherein the communications are conducted as online chats between customers and chat agents.

3. The method of claim 1, wherein each of the chat summaries for a communication is generated by:
obtaining a transcript of the communication;
extracting textual features from the transcript based on a feature extraction model; and
automatically generating the chat summary for the communication based on the textual features in accordance with a summary generation model, wherein the chat summary characterizes the transcript in accordance with one or more categories.

4. The method of claim 1, wherein the creating the chat summary modification history for a chat summary comprises:
receiving information specifying a sequence of modifications to be applied to the chat summary generated based on a communication involving a customer and a service agent;
applying each of the modifications in the sequence to generate a corresponding updated version of the chat summary;
indexing the chat summary modification history based on information related to the customer and/or the service agent;
generating the chat summary modification history based on the chat summary, the updated versions of the chat summary with the index.

5. The method of claim 4, further comprising assessing the models by:
with respect to each of the chat summary modification histories associated with a chat summary,
obtaining at least one discrepancy between the chat summary and at least one of the updated versions of the chat summary in the chat summary modification history,
determining a metric based on the at least one discrepancy; and
obtaining an evaluation based on the metrics obtained for the respective chat summary modification histories to derive an assessment of the performance of the models.

6. The method of claim 1, wherein
the feedback data is generated as training data with each training sample corresponding to a pair including content of a communication and a final version of a chat summary for the communication, wherein
the content of the communication serves as an input for training, and
the final version of the chat summary for the communication serves as a ground truth chat summary.

7. The method of claim 6, wherein the updating the models based on the feedback data comprises:
based on each training sample in the feedback data,
generating, based on the models, a predicted chat summary based on the input content of a communication,
computing a loss based on the predicted chat summary and the ground truth chat summary, and
determining, if the loss satisfies a pre-determined criterion, an adjustment to be made to parameters of the models in order to minimize the loss.

8. A machine readable and non-transitory medium having information recorded thereon, wherein the information, when read by the machine, causes the machine to perform the following steps:
automatically generating chat summaries for communications between customers and service agents based on models previously learned via training data;
creating a chat summary modification history for each of the chat summaries, wherein the chat summary modification history incudes a chat summary automatically generated using the models and one or more updated versions of the chat summary;
receiving a request from an inquiring customer;
responding to the request based on a chat summary modification history created with respect to a chat summary on a previous communication involving the inquiring customer;
generating feedback data based on the chat summary modification histories; and
updating the models based on the feedback data.

9. The medium of claim 8, wherein the communications are conducted as online chats between customers and chat agents.

10. The medium of claim 8, wherein each of the chat summaries for a communication is generated by:
obtaining a transcript of the communication;
extracting textual features from the transcript based on a feature extraction model; and
automatically generating the chat summary for the communication based on the textual features in accordance with a summary generation model, wherein the chat summary characterizes the transcript in accordance with one or more categories.

11. The medium of claim 8, wherein the creating the chat summary modification history for a chat summary comprises:
receiving information specifying a sequence of modifications to be applied to the chat summary generated based on a communication involving a customer and a service agent;
applying each of the modifications in the sequence to generate a corresponding updated version of the chat summary;
indexing the chat summary modification history based on information related to the customer and/or the service agent;
generating the chat summary modification history based on the chat summary, the updated versions of the chat summary with the index.

12. The medium of claim 11, wherein the information, when read, further causes the machine to perform the step of assessing the models by:
with respect to each of the chat summary modification histories associated with a chat summary,
obtaining at least one discrepancy between the chat summary and at least one of the updated versions of the chat summary in the chat summary modification history,
determining a metric based on the at least one discrepancy; and
obtaining an evaluation based on the metrics obtained for the respective chat summary modification histories to derive an assessment of the performance of the models.

13. The medium of claim 8, wherein
the feedback data is generated as training data with each training sample corresponding to a pair including content of a communication and a final version of a chat summary for the communication, wherein
the content of the communication serves as an input for training, and
the final version of the chat summary for the communication serves as a ground truth chat summary.

14. The medium of claim 13, wherein the updating the models based on the feedback data comprises:
based on each training sample in the feedback data,
generating, based on the models, a predicted chat summary based on the input content of a communication,
computing a loss based on the predicted chat summary and the ground truth chat summary, and
determining, if the loss satisfies a pre-determined criterion, an adjustment to be made to parameters of the models in order to minimize the loss.

15. A system, comprising:
an automated chat summary generator implemented by a processor and configured for automatically generating chat summaries for communications between customers and service agents based on models previously learned via training data;
a chat summary modification unit implemented by a processor and configured for creating a chat summary modification history for each of the chat summaries, wherein the chat summary modification history incudes a chat summary automatically generated using the models and one or more updated versions of the chat summary;
a user service module implemented by a processor and configured for
receiving a request from an inquiring customer, and
responding to the request based on a chat summary modification history created with respect to a chat summary on a previous communication involving the inquiring customer;
a chat summary quality assessment unit implemented by a processor and configured for generating feedback data based on the chat summary modification histories, wherein the feedback data is used for updating the models.

16. The system of claim 15, wherein
the communications are conducted as online chats between customers and chat agents; and
each of the chat summaries for a communication is generated by:
obtaining a transcript of the communication,
extracting textual features from the transcript based on a feature extraction model, and
automatically generating the chat summary for the communication based on the textual features in accordance with a summary generation model, wherein the chat summary characterizes the transcript in accordance with one or more categories.

17. The system of claim 15, wherein the creating the chat summary modification history for a chat summary comprises:
receiving information specifying a sequence of modifications to be applied to the chat summary generated based on a communication involving a customer and a service agent;
applying each of the modifications in the sequence to generate a corresponding updated version of the chat summary;
indexing the chat summary modification history based on information related to the customer and/or the service agent;
generating the chat summary modification history based on the chat summary, the updated versions of the chat summary with the index.

18. The system of claim 17, wherein the chat summary quality assessment unit is further configured for assessing the models by:
with respect to each of the chat summary modification histories associated with a chat summary,
obtaining at least one discrepancy between the chat summary and at least one of the updated versions of the chat summary in the chat summary modification history,
determining a metric based on the at least one discrepancy; and
obtaining an evaluation based on the metrics obtained for the respective chat summary modification histories to derive an assessment of the performance of the models.

19. The system of claim 15, wherein
the feedback data is generated as training data with each training sample corresponding to a pair including content of a communication and a final version of a chat summary for the communication, wherein
the content of the communication serves as an input for training, and
the final version of the chat summary for the communication serves as a ground truth chat summary.

20. The system of claim 19, wherein the updating the models based on the feedback data comprises:
based on each training sample in the feedback data,
generating, based on the models, a predicted chat summary based on the input content of a communication,
computing a loss based on the predicted chat summary and the ground truth chat summary, and
determining, if the loss satisfies a pre-determined criterion, an adjustment to be made to parameters of the models in order to minimize the loss.
